(19) United States
(12) Patent Application Publication
(10) Pub. No.: US 2020/0118017 A1
(43) Pub. Date: Apr. 16, 2020

(54) Cohort Event Prediction in a Digital Medium Environment using Regularization

(71) Applicant: Adobe Inc., San Jose, CA (US)

(72) Inventors: Jian Li, Sunnyvale, CA (US); Zhenyu Yan, Cupertino, CA (US); Xiang Wu, Mountain View, CA (US)

(73) Assignee: Adobe Inc., San Jose, CA (US)

(21) Appl. No.: 16/159,486

(22) Filed: Oct. 12, 2018

(51) Int. Cl. G06N 7/00; G06N 5/02; G06N 5/04; G06N 99/00; G06F 17/18; G06F 11/34; G06F 17/30

(52) U.S. Cl. CPC G06N 7/005; G06N 5/025; G06N 5/04; G06F 17/30551; G06F 17/18; G06F 11/3438; G06F 17/30294; G06N 99/005

(57) ABSTRACT

Techniques and systems are described that employ cohort event prediction using regularization to predict occurrence of future events. Regularization is used to penalize differences between adjacent cohorts and ages. As a result, regularization supports increased flexibility and provides an optimal tradeoff between bias and variance with respect to conventional “all-or-nothing” techniques as described above. Regularization, for instance, may be used to leverage similarities between cohorts and ages and yet still support information that may be particular to specific cohorts. As such, regularization provides a middle ground between conventional approaches.

### BACKGROUND

Digital analytics systems are implemented to analyze “big data” (e.g., Petabytes of data) to gain insights that are not possible to obtain, solely, by human users. In one such example, digital analytics systems are configured to analyze big data to predict occurrence of future events, which may support a wide variety of functionality. Prediction of future events, for instance, may be used to determine when a machine failure is likely to occur, improve operational efficiency of devices to address occurrences of events (e.g., to address spikes in resource usage), resource allocation, and so forth.

In other examples, this may be used to predict events involving user actions. Accurate prediction of user actions may be used to manage provision of digital content and resource allocation by service provide systems. In this way, event prediction of user interactions by digital analytics systems improve operation of devices and systems that leverage these predictions. Examples of techniques that leverage prediction of user interactions include recommendation systems, digital marketing systems (e.g., to cause conversion of a good or service), systems that rely on a user propensity to purchase or cancel a contract relating to a subscription, likelihood of downloading an application, signing up for an email, and so forth.

In one example, digital analytics systems employ an Age-Period-Cohort (APC) model to predict a user event as a “churn rate,” e.g., a propensity of a user population to cancel a contract. Users, for instance, may sign up for a subscription for digital content, e.g., to a digital magazine, to a music streaming service, and so forth. Therefore, a churn rate in this example describes a rate, at which, users cancel the subscription from service provider systems that disseminate this digital content.

Conventional APC models are based on age, cohort, and period effects. “Cohorts” describe a collection of entities that initiate interaction with a service provider system within a same period of time. Users, for instance, that sign up for a subscription to stream digital music from a music streaming system during the same month may be considered as part of the same cohort. “Age” describes an amount of time that has passed since the entity initiated this interaction, e.g., an amount of time that has passed since the users have signed up for the subscription. Age may be expressed in a variety of amounts to time, including hours, weeks, months, and so forth. Thus, age effects are variations linked to processes of aging specific to the users being modeled and cohort effects are variations resulting from unique experiences and exposure of users within a respective cohort over time. “Period” effects result from external factors that equally affect all age groups at a particular point in time, e.g., calendar time such as a holiday, and so forth.

Conventional techniques employed by digital analytics system to leverage cohorts as part of generating a prediction involve numerous challenges, especially for churn prediction. For example, conventional techniques used by digital analytics system to predict churn follow an “all-or-nothing approach.” This all-or-nothing approach is implemented by pooling each of the cohorts together or analyzing each cohort separate. In one conventional technique, for instance, a time series model is used to forecast a churn rate of an entirety of a customer base directly, regardless of a cohort, to which, the customers are classified. Thus, this first conventional technique fails to address a variation that may be present between cohorts and as such does not address information that may be available at a cohort level. As a result, a high amount of bias may be encountered by digital analytics systems that employ this first conventional technique.

In a second conventional technique, a churn rate is generated by the digital analytics system for each cohort, individually and independently, using a time/series model. While this technique may address differences between cohorts that is not possible in the first conventional technique, this second conventional technique fails to address information that may be common between cohorts, such as a pattern in churn rate observed as an age of a subscription increases. Thus, this second conventional technique suffers both from high variance and high bias when implemented by digital analytics systems.

Consequently, the first and second conventional techniques, when employed by digital analytics systems, suffer from high bias, high variance, or both. Therefore, these conventional techniques have limited accuracy in event prediction, especially for churn prediction, and result in efficient use of computational resources by systems that employ these conventional techniques.

### SUMMARY

Techniques and systems are described that employ cohort event prediction using regularization to predict occurrence of future events. A cohort model system, for instance, may employ a cohort/age structure to predict occurrence of events for particular cohorts at particular ages that is configured to share information across cohorts and ages. Thus, each cohort share may share information with other cohorts and information may also be shared across ages. As a result, the cohort/age structure supports increased flexibility and provides an optimal tradeoff between bias and variance with respect to conventional “all-or-nothing” techniques as described above.

The techniques described herein also employ regularization in which differences are penalized between adjacent cohorts and ages. Regularization, for instance, may be used to leverage similarities between cohorts and ages and yet still support information that may be particular to specific cohorts. As such, regularization provides an optimal middle ground between conventional approaches. Data, for instance, may be received by the data analytics system that describes occurrence of an event with respect to a plurality of entities over time, e.g., cancellation of a subscription by respective users. To generate the prediction, the digital analytics system first classifies the plurality of entities (e.g., the users) within the data into respective cohorts, e.g., based on when the users signed up for the subscription.

The digital analytics system then estimates occurrence of the event for the plurality of cohorts over a plurality of ages from the data using regularization. The digital analytics system, for instance, may generate a table in which a first axis corresponds to the plurality of cohorts and the second axis corresponds to the plurality of ages. Entries of the table are then estimated from the data by the digital analytics system (e.g., using regression) for respective cohorts at respective ages and as such “fills in” table entries using the data for cohorts and ages described in the data.

Regularization is also employed as part of estimating the occurrence by the digital analytics system, e.g., through regression. Regularization, for instance, may be employed as a penalty as part of estimating the occurrences (e.g., rates of occurrence) to limit variance from adjacent entries in the table. In this way, regularization is used by the digital analytics system to overcome the challenges of conventional “all-or-nothing” techniques that exhibit high variance or bias as described above by providing a middle ground between these conventional approaches.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ cohort model prediction techniques described herein.

FIGS. 2A and 2B depict systems in an example implementation showing operation of the cohort model system of FIG. 1 in greater detail.

FIG. 3 depicts a table in an example implementation having entries of a rate of occurrence as a churn rate that are estimated based on data by the cohort model system of FIG. 1.

FIG. 4 depicts a table in an example implementation having entries of a rate of occurrence as a conditional churn rate that are estimated based on data by the cohort model system of FIG. 1.

FIG. 5 is a flow diagram depicting a procedure in an example implementation in which cohort event prediction with regularization is used to generate a prediction of a rate of an occurrence of an event.

FIG. 6 depicts an implementation showing regularization examples.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Overview

Predicting occurrence of future events is used to support a wide range of functionality, examples of which include device management, control of dissemination of digital content to users, and so forth. Conventional techniques to do so, however, especially for churn prediction have limited accuracy due to an “all or nothing” approach as described above. In one conventional example, a time series model is used to forecast a churn rate of an entirety of a customer base directly, regardless of a cohort, to which, the customers are classified. Thus, this first conventional technique fails to address variation that may be present between cohorts and results in a high amount of bias.

In a second conventional technique, a churn rate is generated by the digital analytics system using a time/series model individually and independently for each cohort. Thus, while this second conventional technique may address differences between cohorts, this technique fails to address information that may be common between cohorts, such as a pattern in churn rate observed as an age of a subscription increases.

Consequently, service provider systems that employ these conventional techniques are confronted with inefficient use of computational resources to address these inaccuracies. For example, accuracy in prediction of events involving computational resource usage by a service provide system may result in outages in instances in which a spike in usage is not accurately predicted or over allocation of resources in instances in which a spike in usage is predicted but does not actually occur. Similar inefficiencies may be experienced in systems that relay on predicting events involving user actions, e.g., churn, upselling, conversion, and so forth.

Accordingly, techniques and systems are described that employ cohort event prediction using regularization to predict occurrence of future events. As previously described, conventional all-or-nothing approaches suffer from high bias, high variance, or both. To address this, the techniques described herein employ a cohort/age structure along with regularization in which differences are penalized between adjacent cohorts and ages. As a result, regularization supports increased flexibility for modeling churn and provides an optimal tradeoff between bias and variance with respect to conventional “all-or-nothing” techniques as described above. Regularization, for instance, may be used to leverage similarities between cohorts and ages and yet still support information that may be particular to specific cohorts. As such, regularization provides an optimal middle ground between conventional approaches.

Data, for instance, may be received by the data analytics system that describes occurrence of an event with respect to a plurality of entities over time. In an example involving churn, the plurality of entities corresponds to respective users and the event being predicted is churn, e.g., cancellation of a subscription to receive digital content from a service provider system. Thus, in this example the data describes a point of time at which user interaction is initiated with respect to the service provider system, e.g., to start a subscription by a respective entity. The data also describes a point of time, at which, respective users have cancelled the subscription.

To generate the prediction in this example, the digital analytics system first classifies the plurality of entities (e.g., users) within the data into respective cohorts. The classification of the entities is based on a respective time period from a plurality of time periods, to which, a respective entity belongs. The digital analytics system, for instance, may group the users based on a month at which the users subscribed to a music streaming service of a service provider system. Therefore, users that subscribed to the music streaming service in January may be classified into a first cohort. Users that subscribed to the music streaming service in February may be classified into a second cohort, and so on. As part of this, the digital analytics system generates a table for the plurality of cohorts over a plurality of ages from the data that describes occurrences of the event at respective cohort/age entries in the table. The plurality of ages, for instance, may describe amounts of time that are the same as or different from the amounts of time described by the respective time periods used to classify the entities into cohorts. As such, “time periods” refer to a criterion as to how entities are classified into cohorts and “age” refers to an amount of time has passed since a respective entity began interaction with the system and/or is referenced in the data.

The table is then passed to a statistical model generation module to generate a prediction of future occurrences of the event for respective cohorts. To do so, a regression module is used to estimate historical parameters. Regularization is also employed as part of estimating the historical parameters (e.g., through regression), which overcomes the limitations of the conventional APC models.

Regularization, for instance, may be employed as a penalty as part of estimating the occurrences (e.g., rates of occurrence) to limit variance from adjacent entries in the table. In one example, regularization includes penalizing differences in the rate of occurrence between adjacent levels of the plurality of cohorts. In another example, regularization includes penalizing differences in the rate of occurrence between adjacent ages of the plurality of ages in the table. This is used to account for an observation that nearby cohorts and/or ages between cohorts typically exhibit similar effects on the rate of occurrence of the event, e.g., churn. In this way, regularization and cohort/age structure is used by the digital analytics system to overcome the challenges of conventional “all-or-nothing” techniques that exhibit high variance or bias as described above by providing a middle ground between these conventional approaches.

The historical parameters are then used by the digital analytics system to generate a statistical model. The digital analytics system, for instance, may select a regression model based on the historical parameters from a plurality of preconfigured regression models, e.g., an ARIMA model, exponential smoothing model, Poisson regression model, and so forth. The digital analytics system then performs regression (e.g., logistic regression) to “fit” the selected model to the historical parameters, i.e., the estimated rates of occurrence for respective cohorts at respective ages, and as such generate the statistical model from the table.

The statistical model is then used by the digital analytics system to generate a prediction of occurrence of the event, e.g., a rate of occurrence of the event at a future age as a future parameter. Continuing with the previous table example, the digital analytics system employs the statistical model to generate a predication of a table entry in the future that is not described by the data, i.e., is not “filled in” by the known data. The statistical model, for instance, may be used to generate the prediction for a respective cohort of the plurality of cohorts defined by the first axis for a respective age described by the plurality of ages defined by the second axis of the table. In one example, this is performed as a weighted sum of a log-likelihood of the known table entries in the table, together. In this way, the digital analytics system may generate a prediction with increased accuracy over conventional techniques and shares data between cohorts and ages.

Besides the cohort and age effects described above, the digital analytics system also supports feature engineering to leverage other variables of predictive power, such as to address aggregated product usage, promotions, data source indicates, temporal parameters such as particular points in time (e.g., when a subscription is about to “run”), change of accounting rules, and so forth. Factors that address these features may be included as covariates in an objective function of the statistical model used to generate the prediction by the digital analytics system. Conventional APC models does not support feature engineering. This is because conventional APC models incur identification issues since the age-period-cohort features have consumed too many degrees of freedom.

Identification issues involve identifying a particular statistical model that is to be selected to model the data. Conventional APC models are typically subject to this issue by modeling age and cohort effects as described above as well as period effects. Period effects result from external factors that equally affect all age groups at a particular point in time, e.g., calendar time such as a holiday, and so forth. However, in some domains such as customer churn predication, while there are significant cohort and age effects, period effects may be limited to a few instances, e.g., retail events such as “Black Friday” or “Cyber Monday.”

According, in such instances, the digital analytics systems described herein includes indicators that are used as part of the objective function in order to generate the prediction, instead of using the period effects. In this way, the identification problems of conventional APC model are overcome by reducing the degrees of freedom introduced by conventional period effects on generating a prediction. And yet, the techniques described herein may still address nuances of particular domains, such as customer churn prediction using additional covariates introduced to the objective function. This improves operation and accuracy of computing devices that employ these techniques and enable functionality that is simply not possible using conventional techniques because of the high degree of freedom introduced by also address period effects.

### Term Examples

“Conversion” is an event involving a purchase a good or service, e.g., digital content from a service provider system.

A “cohort” is a collection of entities that initiate interaction with a service provider system within a same period of time. In one example, a cohort is a collection of customers who convert in the same period, e.g., subscribe to receive digital content from a service provider system within the same month.

A “cohort size” is a number of entities included in a respective cohort of a plurality of cohorts. In one example, cohort size is based on the number of customers in the same cohort that subscribed to receive digital content from a service provider system. In other words, the number of new customers acquired in the same period of time.

“Age” is an amount of time that has passed since interaction with the service provider began and/or an amount of time for a respective entity described in the data. In one example, age is an amount of time that has passed since a customer became a paid user of a service provider system.

“Churn” is an example of occurrence of an event, in which, user interaction with a service provider system cease. In one example, churn involves cancellation of a contract (e.g., subscription) to receive digital content from a service provider system, i.e., product cancellation. A “churn rate” is a ratio of churns to the base. Different choices of bases may lead to different churn rates.

A “conditional churn rate” is a ratio of churns at certain age to the number of remaining entities at the beginning of that age. For instance, the conditional churn rate of a first cohort at the age of 2 would be:

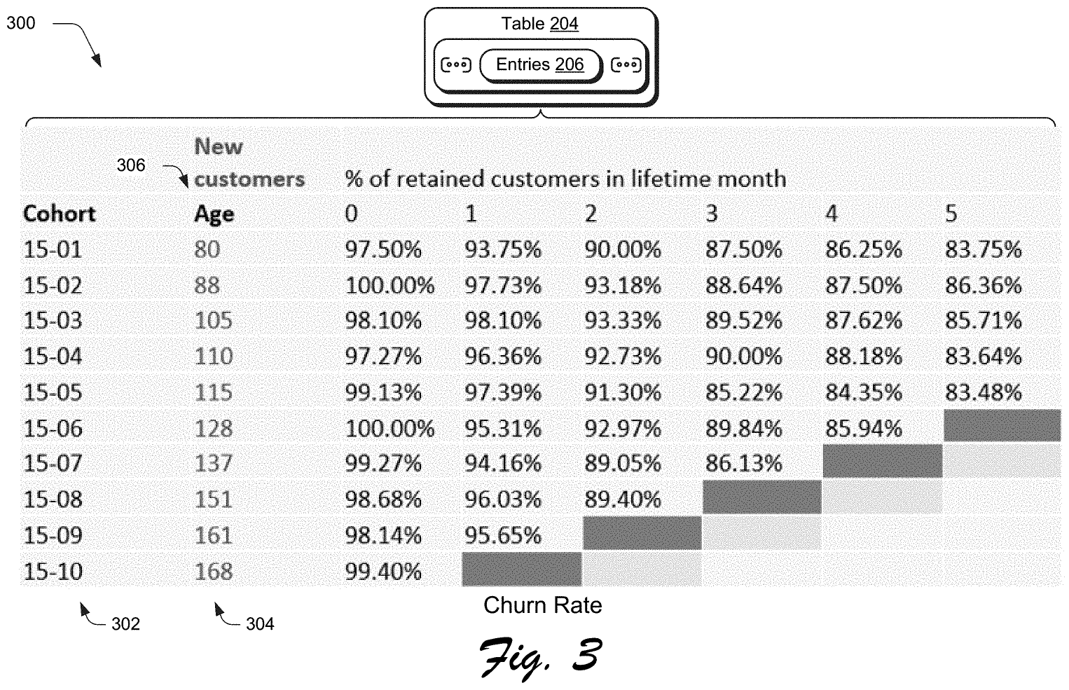

(number of churns of the first cohort at the age of 2)/(number of remaining customers of the first cohort at the beginning at the age of 2), or numerically equal to (93.75-90)/(93.75) as shown at Table 300 of FIG. 3.

In the following discussion, an example environment is first described that may employ the techniques described herein. Example procedures and techniques are then described which may be performed in the example environment as well as other environments. Consequently, performance of the example procedures is not limited to the example environment and the example environment is not limited to performance of the example procedures.

### Example Environment

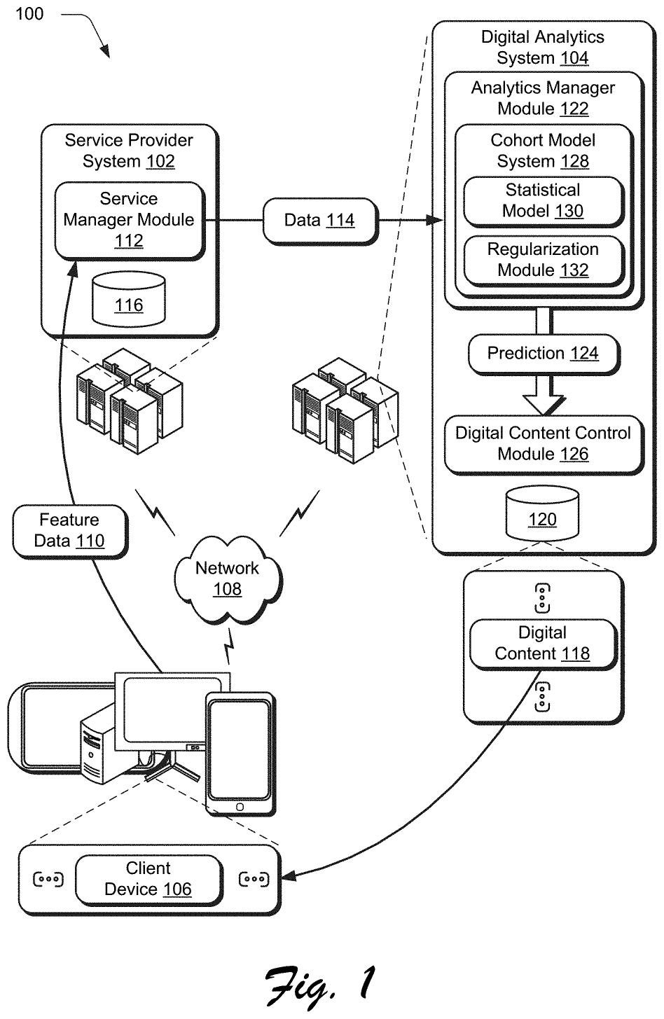

FIG. 1 is an illustration of a digital medium environment 100 in an example implementation that is operable to employ cohort event prediction techniques in a digital analytics system as described herein. The illustrated environment 100 includes a service provider system 102, a digital analytics system 104, and a plurality of client devices, an example of which is illustrated as client device 106. In this example, events are described involving user actions performed through interaction with client devices 106. Other types of events are also contemplated, including device events (e.g., failure, resource usage), and so forth that are achieved without user interaction. These devices are communicatively coupled, one to another, via a network 108 (e.g., Internet) and may be implemented by a computing device that may assume a wide variety of configurations.

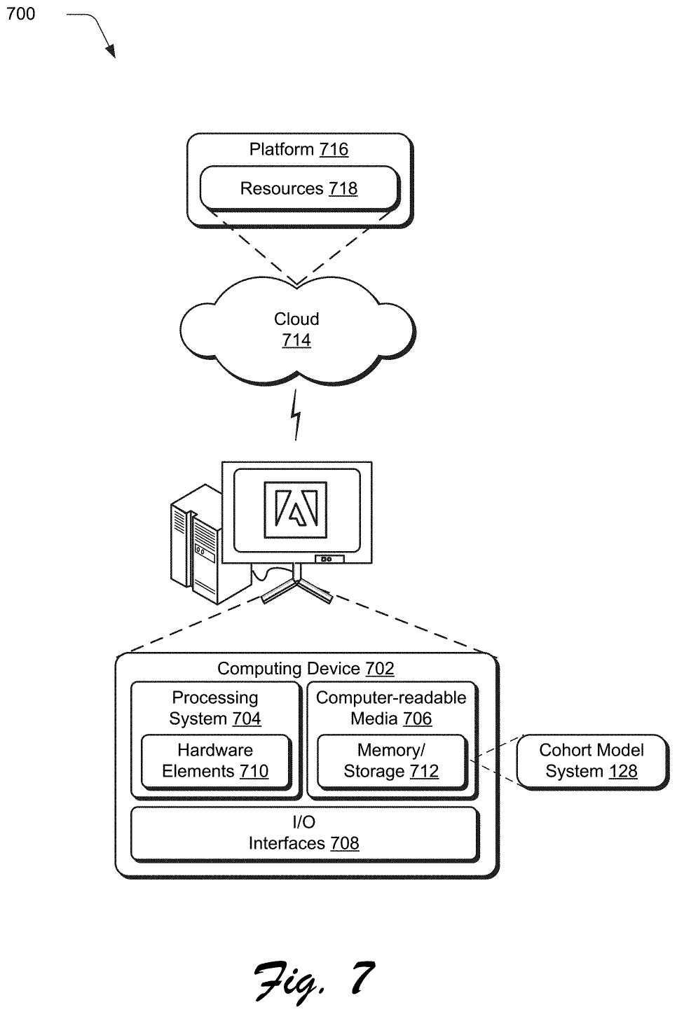

A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, a computing device may be representative of a plurality of different devices, such as multiple servers utilized by a business to perform operations “over the cloud” as shown for the service provider system 102 and the digital analytics system 104 and as further described in FIG. 7.

The client device 106 is illustrated as engaging in user interaction with a service manager module 112 of the service provider system 102. As part of this user interaction, feature data 110 is generated. The feature data 110 describes characteristics of the user interaction in this example, such as demographics of the client device 106 and/or user of the client device 106, network 108, events, locations, and so forth. The service provider system 102, for instance, may be configured to support user interaction with digital content 118. Data 114 is then generated (e.g., by the service manager module 112) that describes this user interaction, characteristics of the user interaction, the feature data 110, and so forth, which may be stored in a storage device 116.

Digital content 118 may take a variety of forms and thus user interaction and associated events with the digital content 118 may also take a variety of forms in this example. A user of the client device 106, for instance, may read an article of digital content 118, view a digital video, listen to digital music, view posts and messages on a social network system, subscribe or unsubscribe, purchase an application, and so forth. In another example, the digital content 118 is configured as digital marketing content to cause conversion of a good or service, e.g., by “clicking” an ad, purchase of the good or service, and so forth. Digital marketing content may also take a variety of forms, such as electronic messages, email, banner ads, posts, articles, blogs, and so forth. Accordingly, digital marketing content is typically employed to raise awareness and conversion of the good or service corresponding to the content. In another example, user interaction and thus generation of the data 114 may also occur locally on the client device 106.

The data 114 is received by the digital analytics system 104, which in the illustrated example employs this data to control output of the digital content 118 to the client device 106. The digital content is illustrated as stored in a storage device 120. An analytics manager module 122 is implemented to generate a prediction 124 (e.g., of an event occurrence) which is then used by a digital content control module 126 to control which items of the digital content 118 are output to the client device 106, e.g., directly via the network 108 or indirectly via the service provider system 102. The prediction 124, for instance, may be used to predict occurrence of an event (e.g., whether or not the event will occur within a corresponding period of time) based on an observation obtained from the client device 106 as expressed by the data 114.

The prediction 124, for instance, may be configured to specify whether the client device 106 is likely to purchase or cancel a subscription. The prediction 124 may then be used by the digital content control module 126 to control output of digital content 118 to the client device 106. This may include use of digital content 118 to encourage a user of the client device 106 to purchase the subscription and/or convince the user to retain and not cancel a subscription through use of digital marketing content. Although the digital content 118 is illustrated as maintained in the storage device 120 by the digital analytics system 104, this digital content 118 may also be maintained and managed by the service provider system 102, the client device 106, and so forth.

To generate this prediction 124, the analytics manager module 122 includes a cohort model system 128 that is representative of functionality to generate a statistical model 130 from the data 114 and then use the statistical model 130 to generate the prediction 124. As previously described, conventional all-or-nothing approaches suffer from high bias, high variance, or both. To address this, the cohort model system 128 is configured to employ a regularization module 132 as part of generating the statistical model 130. The regularization module 132 is configured to penalize differences in estimated values between adjacent cohorts and/or ages. As a result, regularization techniques leveraged by the regularization module 132 support increased flexibility for modeling churn and provides an optimal tradeoff between bias and variance with respect to conventional “all-or-nothing” techniques as described above.

The cohort model system 128, for instance, may begin by estimating cohort and age effects from the data 114 (e.g., and additional covariates as part of feature engineering) by fitting a weighted logistic regression with regularization using the regularization module 132. Thus, at this point estimates may be obtained for occurrences of events by respective cohorts at respective ages and thus “fill in” corresponding entries in a table based on the data 114.

The cohort model system 128 then generates the statistical model 130 based on the estimated cohort and age effects, e.g., an estimated rate of occurrence for respective cohorts at respective ages. In one example, the cohort model system 128 first selects a regression model from a plurality of preconfigured regression models, e.g., an ARIMA model, an exponential smoothing model, a Poisson regression model, and so forth. The entries of the table are then used to fit the selected model to the data 114 thereby generating the statistical model 130.

The statistical model 130 is then used by the cohort model system 128 to generate predictions 124, e.g., for unfilled table entries for points of time in the future. In this way, the cohort model system 128, through use of the regularization module 132, may support increased accuracy is generating the prediction 124 with improved efficiency of computational resources. Further discussion of this and other examples is included in the following Cohort Event Prediction with Regularization section and Implementation Example section.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

### Cohort Event Prediction with Regularization

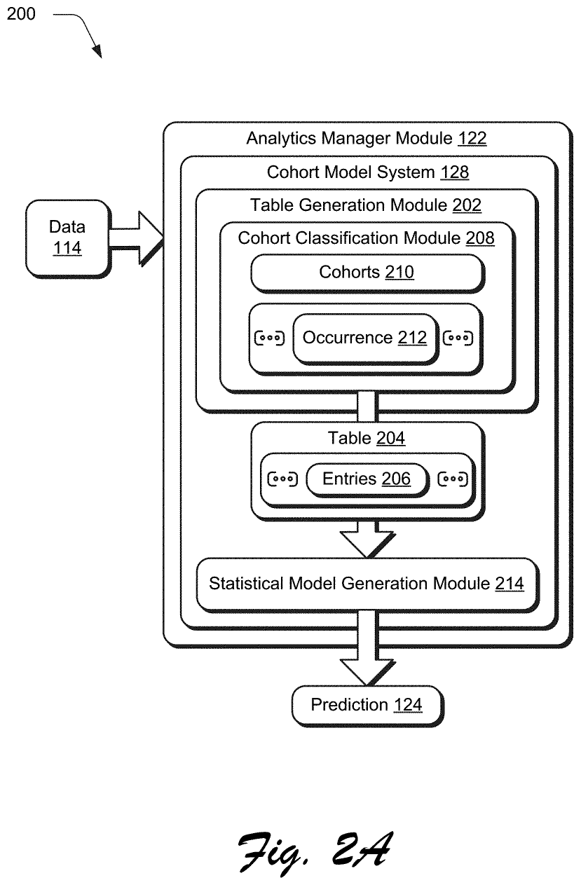

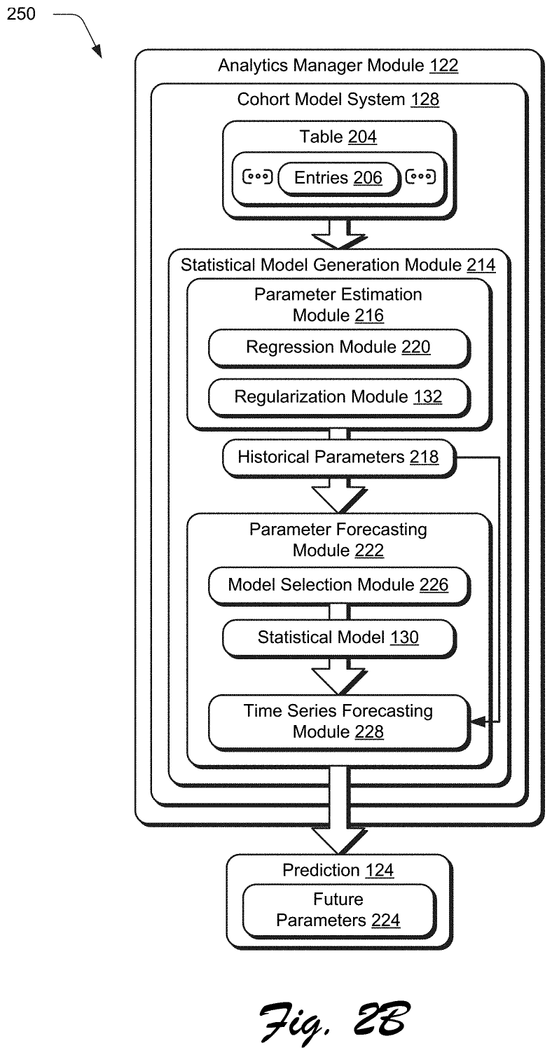

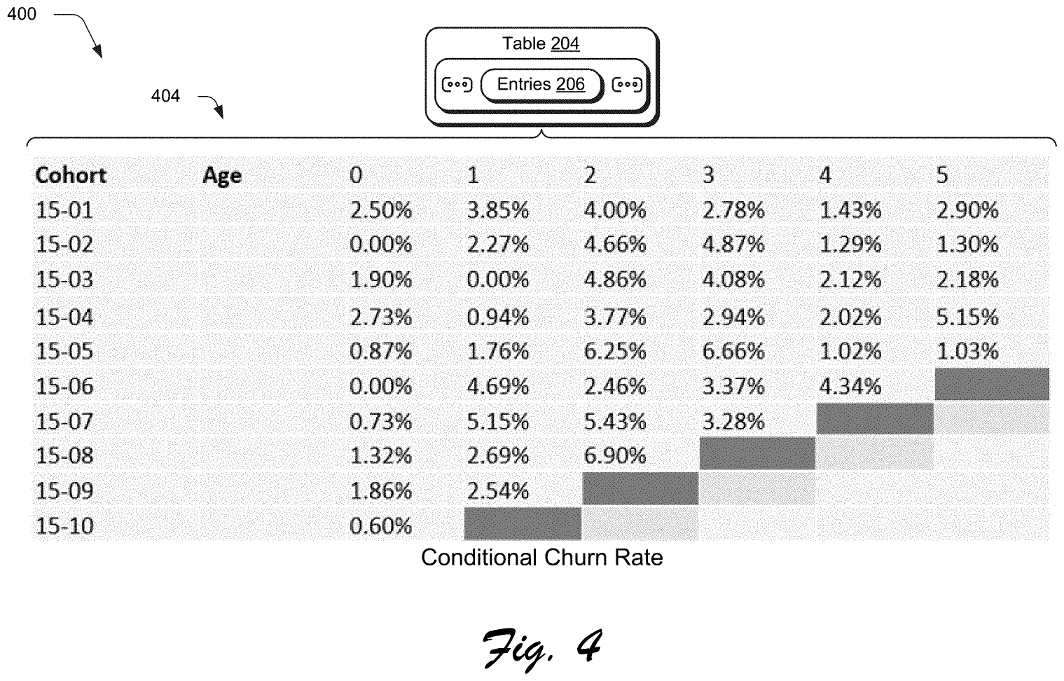

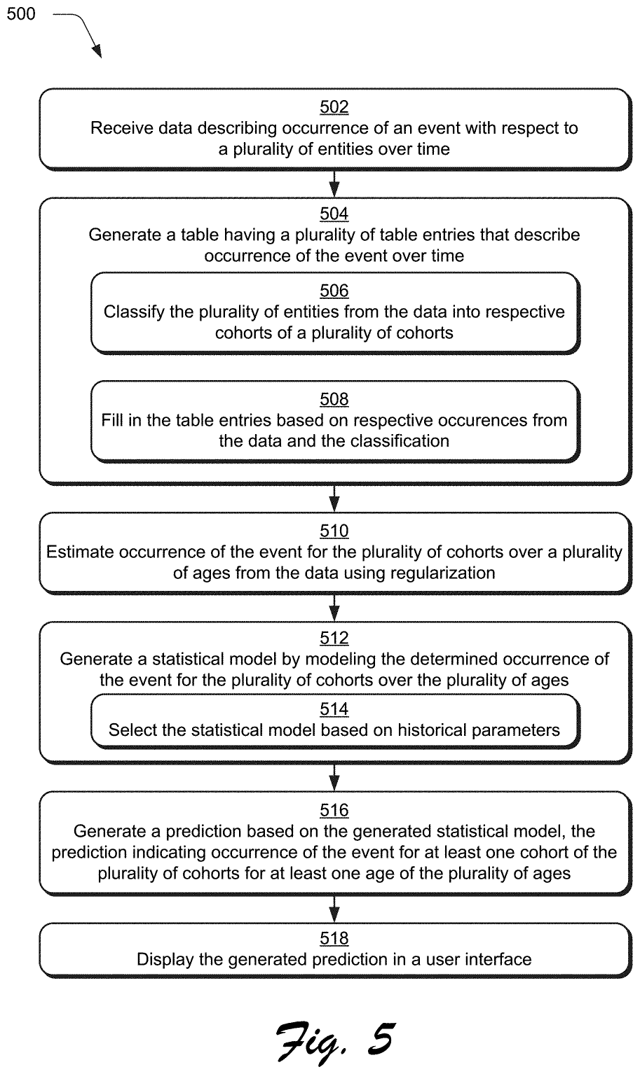

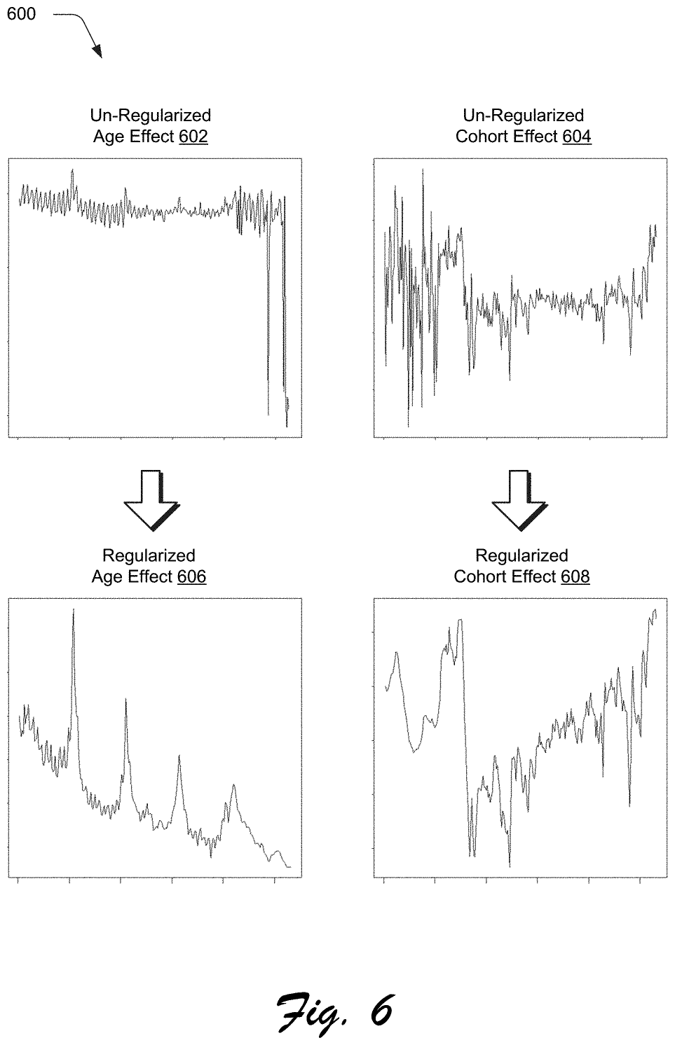

FIGS. 2A and 2B depict systems 200, 2500 in an example implementation showing operation of the cohort model system 128 of FIG. 1 in greater detail. FIG. 3 depicts a table 300 in an example implementation having entries of a rate of occurrence as a churn rate are estimated based on the data 114 of FIG. 1 by the cohort model system. FIG. 4 depicts a table 400 in an example implementation having entries of a rate of occurrence as a conditional churn rate are estimated based on the data 114 of FIG. 1 by the cohort model system 128. FIG. 5 depicts a procedure 500 in an example implementation in which cohort event prediction with regularization is used to generate a prediction of an occurrence of an event. FIG. 6 depicts an implementation 600 showing regularization examples.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 1-5.

To begin at FIG. 2A, data 114 is received by the analytics manager module 122 that describes occurrence of an event with respect to a plurality of entities over time (block 502). The data 114, for instance, may describe a time series of events as corresponding to respective entities. As previously described, a variety of events may be described that may occur with respect to a variety of different entities. The entities, for instance, may correspond to devices and the event may involve operation of those devices. Examples of such device events include device failure, resource usage (e.g., network, processing system, and/or storage device usage) that is greater than or less than a threshold amount to identify spikes and lulls, and so forth. Thus, the data in this example describes respective devices, occurrence of operations by the devices, and when those operations occurred, e.g., through timestamps.

In another example, the entities correspond to users and thus the events may correspond to user interactions. Examples of user interactions that may be described by the data 114 include user interactions involving digital marketing systems (e.g., conversion of a good or service, selection of an ad as a “click”), purchase or cancellation of a contract relating to a subscription, download of an application, signing up for an email or blog access, and so forth. Thus, in this example the data 114 describes respective users, actions taken by the users, and when those actions occurred. As such, the data 114 may be received from a variety of different entities, such as a service provider system 102 (e.g., social network service, ecommerce service), from the client devices 106 directly (e.g., through monitored user interaction with digital marketing content), and so forth.

The data 114, once received, is provided as an input by the cohort module system 128 to a table generation module 202. The table generation module 202 is representative of functionality to generate a table 204 including a plurality of entries 206 by preprocessing the data 114. The plurality of entries 206 describe occurrence of events by respective entities over time from the data 114 (block 504), e.g., a rate of occurrence, a number of times the occurrence happened with respect to a particular age by a particular subset of the entities, and so forth.

To do so, the data is processed by a cohort classification module 208. The cohort classification module 208 is representative of functionality to classify a plurality of entities described by the data 114 into respective cohorts 210 of a plurality of cohorts (block 506). As previously described, a cohort is a collection of entities described by the data 114. Accordingly, the cohort classification module 208 is configured to group entities together based on a criterion. One example of such a criterion is a time, at which, the entity initiated a type of interaction with a service provider system 102. The entities, for instance, in a device scenario may indicate when the entity “was made operational” as part of a system, e.g., a server, storage device, or network communication device added to a server farm. In a user event prediction scenario, this may indicate when the user signed a contract for a subscription, started streaming digital content, and so forth. Thus, in this example the criterion used to assign the entities to respective cohorts is temporal, e.g., a particular hour, day, week, month, year, and so forth. A variety of other criteria may also be used to assign entities to respective cohorts.

As shown in the table 300 of FIG. 3, for instance, a first axis 302 of the table is formed that includes the plurality of entities arranged into respective cohorts of a plurality of cohorts. The cohorts in this example are classified by the cohort classification module 208 based on a time, at which, a user became a paid user of the service provider system 102, e.g., to stream digital content 118, download digital content 118 (e.g., digital music, stock digital images, stock digital videos), and so forth. Thus, this is a time at which the users became “new customers” of the service provider system 102, which are arranged sequentially in time as cohorts 15-01, 15-02, . . . , 15-10 along the first axis 302 in the table 300. A number of entities 304 included in the respective cohorts is also indicated in the table 300 in the illustrated example. Age 306 is depicted along a second axis in the table 300. As previously described, an amount of time expressed by the age may be the same as or different than an amount of time used to classify entities into respective cohorts.

FIG. 4 depicts an example of a table 400 in which conditional churn rates derived from the table 300 of FIG. 3 are shown. The table 400 also includes a first axis 402 for cohorts and a second axis 404 defining age. The conditional churn rate is a ratio of churns at a particular age (e.g., along the second axis 404) to a number of remaining customers at the beginning of that age for a respective cohort along the first axis 402. For instance, the conditional churn rate of cohort 15-01 at the age of 2 is a (number of churns of 15-01 at the age of 2)/(number of remaining customers of 15-01 at the beginning at the age of 2), or numerically equal to (93.75-90)/(93.75) based on the table 300 of FIG. 3. Thus, a variety of occurrences and rates of occurrences may be expressed by entries 206 in the table 204 from the data 114.

Return will now be made again to FIG. 2A, the plurality of cohorts 210 resulting from the classification are then used, along with ages for the respective cohorts 210, to fill in entries 206 in the table 204 based on respective occurrences 212 from the data 114 (block 508). The cohort classification module 208, for instance, may arrange occurrences 212 from the data 114 accordingly to a plurality of ages for each of the respective cohorts in order to “fill in” the entries 206 of the table.

The table 204 and entries 206 are then passed as an input to a statistical model generation module 214 to generate the prediction 124 of a future occurrence of the event. To do so as shown in FIG. 2B, the statistical model generation module 214 first employs a parameter estimation module 216 to estimate occurrence of the event for the plurality of cohorts over a plurality of ages from the data using regularization (block 510), e.g., historical parameters 218 from the table 204. The parameter estimation module 216, for instance, is configured to estimate cohort effects, age effects, and other auxiliary variables by fitting a weighted logistic regression as represented by a regression module 220, an example of which is further described in the Implementation Example section.

As part of this estimation, the parameter estimation module 216 also employs regularization, functionality of which is represented by the regularization module 132. Regularization helps to ensure a proper complexity of the statistical model 130 that addresses cohorts and ages individually and also commonality between cohorts and ages together, which is not possible in conventional techniques.

Regularization, for instance, may be employed as a penalty as part of an objective function by the regularization module 132 to estimate the occurrences (e.g., rates of occurrence) to limit variance from adjacent entries in the table 204. In one example, regularization includes penalizing differences in the occurrences between adjacent levels of the plurality of cohorts. In another example, regularization includes penalizing differences in the occurrences between adjacent ages of the plurality of ages in the table. This is used to account for an observation that nearby cohorts and/or ages between cohorts typically exhibit similar effects on the rate of occurrence of the event, e.g., churn. In this way, regularization of the regularization module 132 is used by the cohort model system 128 to overcome the challenges of conventional “all-or-nothing” techniques that exhibit high variance or bias as described above by providing a middle ground between these conventional approaches in generating the historical parameters 218.

Compared with conventional APC models, the techniques described herein used to generate the historical parameters 218 may ignore period effects, which are insignificant in some prediction scenarios and introduce too many degrees of freedom which introduce identification issues as described above. Thus, elimination of the period effects from the objective function may improve accuracy and efficient use of computational resources. Implementations are also contemplated, however, in which period effects are incorporated for scenarios in which period effects are significant for prediction purposes.

In this way, the parameter estimation module 218 is used to generate the historical parameters 218 using regression by the regression module 220 and regularization by the regularization module 132. The historical parameters 218 are passed from the parameter estimation module 216 to a parameter forecasting module 222 to generate a prediction of future parameters 124 based on the historical parameters 218.

Next, a statistical model 130 is generated by the parameter forecasting module 222 by modeling the determined occurrence of the event for the plurality of cohorts over the plurality of ages (block 512), e.g., the historical parameters 218 received from the parameter estimation module 216. As part of this, the parameter forecasting module 222 employs a model selection model 226 to select the statistical model 130 based on the historical parameters 218 (block 514). Examples of models, from which, the statistical model may be selected by the model selection module 226 include regression statistical models such as an ARIMA model, an exponential smoothing model, a Poisson regression model, and so forth. The historical parameters 218 are thus fit to the select statistical model 130 to be used for forecasting the future parameters 224.

The statistical model 130, for instance, is then communicated from the model selection module 226 to a time series forecasting module 228 to generate the future parameters 224 that serve as a basis for the prediction 124 based on the historical parameters 218. The prediction indicates occurrence of the event for at least one cohort of the plurality of cohorts for at least one age of the plurality of ages (block 516). The time series forecasting module 228, for instance, may employ an objective function as a weighted sum of a log-likelihood of each of the known entries in the table as indicated by the historical parameters 218 to predict a future value for an unfilled entry in the table 204, i.e., a value that is not known from the data 114, directly.

As shown in the tables 300, 400 of FIGS. 3 and 4, for instance, shaded entries in the table are depicted as identifying future cohort/age combinations that are to be subject of the prediction 124, i.e., are not known directly in the data 114 but are then predicted based on the historical parameters 218 using the statistical model 130 to generate the future parameters 224, e.g., rate of event occurrence. The generated prediction 124 may be employed in a variety of ways, such as displayed in a user interface (block 518), used to control output of digital content 118, control resource usage of devices, and so forth.

The cohort model system 128 may select statistical models at a variety of different stages as part of generating the prediction 124 by the illustrated systems 200, 250. In one example, there is a model selection step for hyper-parameter selection, which may be performed at a predefined frequency such as once a quarter or less frequently. This is accomplished by reiterating the illustrated steps of the cohort model system 128 of the systems 200, 250 of FIGS. 2A and 2B for a number of times with different hyper-parameters, and then choosing the optimal parameters among the calculations. Another model selection step is used to select a parameter for regularization as performed by the regularization module 132. On the other hand, the model selection module 226 of the parameter forecasting module 222 is configured to select a proper statistical model for forecasting future parameters 224. Further discussion of estimation of entries and generation of the prediction is included in the following Implementation Example section.

### Implementation Example

Generation of the prediction 124 by the cohort model system 128 may be addressed as a task to “fill in” unknown entries in the table 204, e.g., the shaded areas of tables 300, 400 of FIGS. 3 and 4, respectively. To accomplish this, the analytics manager module 122 in this Implementation Example is configured to find 1) the cohort size, and 2) a conditional churn rate for corresponding entries in the table 204 that are unfilled.

Let α₁ denote a cohort effect of the i-th cohort, βⱼ denote the age effect of age j, and pᵢⱼ denote the conditional churn rate of cohort i at age j. Based on the assumption of logistic regression, the following expression is obtained:

pᵢⱼ=(1+exp{αᵢ+βⱼ+cᵢⱼ})⁻¹,

where cᵢⱼ represents optional auxiliary variables (which may include multiple auxiliary variables) as part of feature engineer that may account for side information useful to the statistical model. For instance, this covariate may identify data sources, counting rules, and so on.

Consider that the numbers of active and churning users of cohort i at age j are Nᵢⱼ and xᵢⱼ respectively, the conditional likelihood function for this entry given the information prior to the entry may be expressed as follows:

pᵢⱼ^{x}^{ᵢⱼ}(1−pᵢⱼ)^{N}^{ᵢⱼ}^{-x}^{ᵢⱼ}.

The main body of the objective function is a weighted sum of the log-likelihood of each of the known entries in the table. The weight is lower as the corresponding time of the entry is older, reflecting the obsolescence of the record.

Σwᵢ₊₁jog[pᵢⱼ^{x}^{ᵢⱼ}(1−pᵢⱼ)^{N}^{ᵢⱼ}^{-x}^{ᵢⱼ}].

In practice, coefficients near the corners of the tables, i.e., the cohort effects of the bottom-left corner and the age effects of the top-right corner of tables 300, 400 of FIGS. 3 and 4, are quite unstable. The reason is the sparsity of data 114 around these two corners compared to the center of the table. Accordingly, the cohort model system 128 applies an elastic net to constrain the difference between adjacent cohorts and ages to obtain stable parameter estimates through use of regularization. Regularization as implemented by an elastic net penalty function as part of a final objective function is described as follows:

e(x)=a|x|+(1−a)x²/2,

Σwᵢ₊ⱼlog[pᵢⱼ^{x}^{ᵢⱼ}(1−pᵢⱼ)^{N}^{ᵢⱼ}^{-x}^{ᵢⱼ}]+λ[Σe(αᵢ−αᵢ₋₁)+Σe(βⱼ−βⱼ₋₁) ].

Thus, generation of the prediction by the cohort model system 128 implements the following functionality. First, parameters are estimated by the cohort model system 128 for cohort effects, age effects, and other auxiliary variables by fitting a weighted logistic regression with regularization. Second, parameter forecasting is implemented for prediction of future events. The cohort effects, age effects, and cohort sizes form a time series. Accordingly, the cohort model system 128 employs model selection procedures to select a statistical model from ARIMA, Exponential Smoothing and Poisson Regression models. This selection may be implemented regularly by the cohort model system 128 (e.g., at predefined intervals) so that the model adapts to cohort trends. The parameters from the previous steps are then used by the cohort model system 128 to reconstruct an occurrence of an event, e.g., a rate of occurrence such as a conditional churn rate Pᵢⱼ to calculate future churns. A variety of other event occurrence predictions are also contemplated as previously described.

In this way, the techniques described herein overcome numerous challenges of conventional APC model techniques, especially for churn forecasting. As previously described, conventional APC models are typically subject to model identification problems. However, in some instances of prediction 124 generation, while there are significant cohort and age effects, there are usually no obvious additional signals in the period effects except for a few special events, such as Black Friday. According, instead of using the period effects as part of the objective function, indicators for these events are used. In this way, the cohort model system 128 avoids the serious identification problem of conventional APC models yet remains flexible.

Besides the cohort and age effects, other variables may also have predictive power, such as the billing day and anniversary day of the subscriptions. Other examples include a change of accounting rules. Accordingly, the cohort model system 128 may address factors for adjusting the change through feature engineering through inclusion of the variable “cᵢⱼ” as described above. In this way, the statistical model 130 supports feature engineering and allows users to make adjustments by selecting the proper features. Conventional APC models does not support feature engineering nor inclusion of extra variables due to identification issues since the age-period-cohort features have consumed too many degrees of freedom.

As described above in relation to the tables 300, 400 of FIGS. 3 and 4, entries data around the corner of the tables is usually sparse, and the estimation becomes unstable in those regions. The estimated parameters of the cohort model (as well as the APC model) could therefore be spiky when the cohort/age/period effects are regarded as time series using conventional techniques. To address these issues, regularization is employed to penalize differences between adjacent cohorts and/or ages. Regularization reduces variance of the estimates (e.g., estimated coefficients), and smooths the cohort/age effects. After imposing regularization, the estimated coefficients are able to address commonalities between cohorts and ages yet still protect nuances particular to specific cohorts. The application of regularization for handling edge effects and smoothing parameters is not possible in conventional APC model techniques.

### Example System and Device

FIG. 7 illustrates an example system generally at 700 that includes an example computing device 702 that is representative of one or more computing systems and/or devices that may implement the various techniques described herein. This is illustrated through inclusion of the analytics manager module 122 including the survival analysis module 128 and the classification module 130. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium analytics environment, a method implemented by at least one computing device, the method comprising:
receiving, by the at least one computing device, data describing occurrence of an event with respect to a plurality of entities over time;
classifying, by the at least one computing device, the plurality of entities from the data into respective cohorts of a plurality of cohorts, the classifying based on a respective time period from a plurality of time periods, to which, a respective said entity belongs;
estimating, by the at least one computing device, occurrence of the event for the plurality of cohorts over a plurality of ages from the data using regularization;
generating, by the at least one computing device, a statistical model by modeling the determined occurrence of the event for the plurality of cohorts over the plurality of ages;
generating, by the at least one computing device, a prediction based on the generated model, the prediction indicating occurrence of the event for at least one cohort of the plurality of cohorts for at least one age of the plurality of ages; and
displaying, by the at least one computing device, the generated prediction in a user interface.

2. The method as described in claim 1, wherein the regularization includes penalizing differences in the estimated occurrence between adjacent levels of the plurality of cohorts.

3. The method as described in claim 1, wherein the regularization includes penalizing differences in the estimated occurrence between adjacent ages of the plurality of ages.

4. The method as described in claim 1, wherein estimating includes fitting a weighted logistic regression to portions of the data that correspond to the respective cohort at the respective age.

5. The method as described in claim 1, wherein the plurality of time periods and the plurality of ages define matching amounts of time.

6. The method as described in claim 1, wherein the generating includes selecting the statistical model from a plurality of models and fitting the statistical model to the estimated occurrence of the event for the plurality of cohorts over the plurality of ages.

7. The method as described in claim 7, wherein the plurality of statistical models include a regression model, an ARIMA model, an exponential smoothing model, or a Poisson regression model.

8. The method as described in claim 1, wherein the predicted occurrence is a rate of occurrence.

9. The method as described in claim 1, wherein the statistical model models:
cohort effects of the plurality of cohorts;
age effects of the plurality of ages; and
at least one feature-engineered covariate.

10. The method as described in claim 9, wherein the feature-engineered covariate is a temporal parameter.

11. In a digital medium analytics environment, a system comprising:
a table generation module implemented at least partially in hardware of a computing device to generate a table having a plurality of entries that describe occurrence of a user event, the table having:
a first axis classifying a plurality of users into respective cohorts of a plurality of cohorts from data, the classifying based on a respective time period from a plurality of time periods, to which, a respective said user belongs; and
a second axis describing a plurality of ages over time;
a statistical model generation module implemented at least partially in hardware of the computing device to generate:
a statistical model by modeling the plurality of entries of the table; and
a prediction of occurrence of the user event based on the plurality of entries of the table modeled by the generated model, the prediction indicating a rate of occurrence of the user event for users included in at least one cohort of the plurality of cohorts for at least one age of the plurality of ages.

12. The system as described in claim 11, wherein the statistical model generation module further comprises a parameter estimation module that is configured to estimate the occurrence for the user event for the plurality of entries in the table using regularization, the regularization including penalizing differences in the rate of occurrence between adjacent levels of the plurality of cohorts within the table.

13. The system as described in claim 11, wherein the statistical model generation module further comprises a parameter estimation module that is configured to estimate the occurrence for the user event for the plurality of entries in the table using regularization, the regularization including penalizing differences in the rate of occurrence between adjacent ages of the plurality of ages within the table.

14. The system as described in claim 11, wherein the statistical model generation module is configured to generate the statistical model by selecting the statistical model from a plurality of statistical models and fitting the selected statistical model to the table.

15. The system as described in claim 14, wherein the plurality of statistical models include a regression model, an ARIMA model, an exponential smoothing model, or a Poisson regression model.

16. The system as described in claim 11, wherein the rate of occurrence is a conditional churn rate.

17. In a digital medium analytics environment, a system comprising:
means for generating a table having a plurality of entries that describe occurrence of an event by a respective entity of a plurality of entities over a plurality of ages, the table generating means including means for classifying the plurality of entities into respective cohorts of a plurality of cohorts in a first axis of the table from the data, the classifying based on a respective time period from a plurality of time periods, to which, a respective said entity belongs; and
means for generating a statistical model by modeling the plurality of entries from the table, the statistical model generating means including means for estimating a rate of occurrence of the event for the plurality of cohorts over a plurality of ages from the data using regularization.

18. The system as described in claim 17, further comprising means for generating a prediction based on the statistical model, the prediction indicating a rate of occurrence of the event for at least one cohort of the plurality of cohorts for at least one age of the plurality of ages.

19. The system as described in claim 18, further comprising means for displaying the generated prediction in a user interface.

20. The system as described in claim 17, wherein the statistical model generating means includes means for selecting the statistical model from a plurality of models and means for fitting the statistical model to the table.
